(19) United States
(12) Patent Application Publication
(10) Pub. No.: US 2008/0277807 A1
(43) Pub. Date: Nov. 13, 2008

(54) Electrostatic Atomisers And Mixing Arrangements

(76) Inventors: Jeffrey Allen, Norfolk (GB); Paul Bartholomew Ravenhill, Norfolk (GB)

Correspondence Address: LUEDEKA, NEELY & GRAHAM, P.C., P O BOX 1871, KNOXVILLE, TN, 37901, US

(21) Appl. No.: 11/575,345

(22) PCT Filed: Sep. 22, 2005
(86) PCT No.: PCT/GB2005/003650

§ 371 Date: Mar. 15, 2007

(30) Foreign Application Priority Data
Sep. 25, 2004 (GB) 0421386.4

(51) Int. Cl. B05B 5/025; F02M 27/04; B05B 5/16; B01F 3/04; B05B 17/04

(52) U.S. Cl. 261/78.1; 239/690

(57) ABSTRACT

A mixing arrangement, comprises an electrostatic atomiser which feeds a first fluid into a walled-channel where it mixes with a second fluid; the electrostatic atomiser incorporating a charging electrode (3) and a nozzle (2) with an array of orifices through which charged particles of the first fluid exit the atomiser; wherein said charging electrode (3) substantially spans said array of orifices; and said charging electrode (3) and said nozzle (2) are pointed neither into nor towards said channel but are shaped and sized to constitute a part of or the entire wall of said channel in which said first and second fluids are mixed.

### FIELD OF THE INVENTION

The invention relates to electrostatic atomisers generally and electrostatic atomisers as incorporated in mixing arrangements. The electrostatic atomisers of this invention may have a number of applications in a large variety of fields ranging from perfume sprays to fuel injection systems for motor vehicles, aircraft and burners. The invention is not limited to any of these particular fields but is defined in the scope of the claims included at the end of this specification.

### BACKGROUND TO THE INVENTION AND PRIOR ART KNOWN TO THE APPLICANT(S)

US 2003/0015594 (ARNOLD J. KELLY) and U.S. Pat. No. 6,474,573 (ARNOLD J. KELLY) are published patent documents which are part of the prior art for this application. In these documents, flat plate nozzles with arrays of orifices are envisaged. However, behind each array of orifices there is provided a multiple of single electrodes which each point specifically towards a single orifice. This prior document also envisages the use of an array of electrodes pointing towards individual orifices. In US 2003/0205629 (ARNOLD J. KELLY), injectors with multiple orifices are presented. The atomisation in these injectors is however also achieved by using a single pointed electrode. Only the tip of the rod electrodes is actually in proximity to the orifices.

The applicant's own prior patent application number PCT/GB2004/000458 is the closest prior art known. In this application, there is shown a rod electrode with a tip essentially spanning across an array of orifices. The single tip of the rod electrode incorporates an array of closely contiguous electrode points. The injector in question has a conventional elongate shape for pointing into a combustion chamber inlet duct.

The prior art injectors essentially deliver fluid particles from a single (or small number) of points which particles progressively spread apart as they are projected further from the orifices. This approach undoubtedly leads to uneven distribution problems of the particles particularly when the fluid ejected from the orifices is destined to be mixed with a second fluid. The distribution problems require in certain systems further downstream mixing processes to achieve an ideal particle distribution.

### SUMMARY OF THE INVENTION

In a first broad independent aspect, the invention provides a mixing arrangement comprising an electrostatic atomiser which feeds a first fluid into a walled-channel where it mixes with a second fluid; the electrostatic atomiser incorporating a charging electrode and a nozzle with an array of orifices through which charged particles of the first fluid exit the atomisers; characterised in that:
Said charging electrode substantially spans said array of orifices; and
Said charging electrode and said nozzle are pointed neither into nor towards said channel but are shaped and sized to constitute a part of or the entire wall of said channel in which said first and second fluids are mixed.

This configuration will allow improved mixing of the first and second fluid together. One of the consequences of this improved level of mixing achieved is that no further mixing arrangements are required downstream from the mixing arrangement. It will also allow an improved mixture to be achieved across the entire channel i.e. a more uniform mixture may be achieved as compared with the prior art. An improved mixture will naturally improve combustion if the mixture is burnt, diffusion of perfume if the invention is applied in a perfume diffuser and medical effectiveness if the invention is applied in an inhaler.

In a second broad independent aspect, the invention provides an electrostatic atomiser comprising a fluid channel, a charging electrode located in said channel and a nozzle with an array of orifices through which charged particles of fluid exit the atomiser, characterised in that said charging electrode substantially spans said array of orifices and said charging electrode and said nozzle have similar overall shapes.

This feature marks a radical departure from the conventional thinking that the electrode is an elongate rod whose tip only matches a nozzle having the shape of the tip. Atomisation from a localised area outwards has the drawback as discussed above in terms of achieving optimum distribution of mixtures. This configuration will allow improved mixing to occur from a variety of unconventional shapes. Atomisers of this kind may be made to fit in a wide variety of applications without necessarily requiring an elongate rod shaped injector for atomisation.

In a subsidiary aspect in accordance with the invention's second broad independent aspect, the charging electrode and nozzle are substantially flat. This configuration may be particularly advantageous as it allows the atomiser to be placed against flat surfaces such as walls. This configuration may have particular applications in perfume atomisation.

In a further subsidiary aspect, the charging electrode and the nozzle are substantially cylindrical in shape. This configuration is ideal to fit in ducts or other cylindrical channels for optimum mixing of fluids.

In a further subsidiary aspect, the charging electrode and nozzle are substantially annular in shape. This may be particularly advantageous when used in gas turbine combustors.

In a subsidiary aspect in accordance with the invention's first broad independent aspect, said first fluid is a liquid and said second fluid is a gas. This feature is particularly advantageous when the mixing arrangement is employed for mixing air and fuel in a conventional combustion chamber inlet duct.

In a further subsidiary aspect, the charging electrode and the nozzle are substantially flat. This will allow improved mixing to occur by covering a portion of a walled-channel.

In a further subsidiary aspect, the charging electrode and the nozzle are substantially cylindrical in shape. This will achieve improved mixing particularly in applications such as a fuel internal combustion inlet duct.

In a further subsidiary aspect, the charging electrode and the nozzle are substantially annular in shape. This will provide gas turbine combustors with improved mixing and consequently lower harmful emissions.

In a further subsidiary aspect, the nozzle and the charging electrode are substantially cylindrical and located substantially longitudinally in the channel, the nozzle's orifices being arranged to cause the first fluid to exit radially outwards. This would also allow improved mixing to occur in the particular situation where the second fluid would mix with the first fluid around the charging electrode and nozzle arrangement.

A medical drug delivery system incorporates a mixing arrangement according to any of the preceding aspects. In this particular field improved mixing will have special advantages for example by lessening the probability of varying dosages distribution throughout the intake for each drug and air delivered mixtures. Conventional drug and air inhalers if the mixture is not correctly distributed run the risk of providing insufficient drug amounts or excessive drug amounts throughout the intake breath.

### BRIEF DESCRIPTION OF THE FIGURES

FIG. 1 shows a perspective exploded view of a flat plate atomiser in accordance with a certain embodiment of the invention.

FIG. 2 shows a cross sectional view of a flat plate atomiser in accordance with a certain embodiment of the invention.

FIG. 3 shows a double-sided orifice plate atomiser in cross sectional view in accordance with a second embodiment of the invention.

FIG. 4 shows a perspective view of a cylindrical atomiser in accordance with a third embodiment of the invention.

FIG. 5 shows a perspective view of a cylindrical centrally located atomiser in accordance with a fourth embodiment of the invention.

FIG. 6 shows a cross sectional view of a section of the inlet duct to an internal combustion chamber incorporating a flat plate atomiser of the kind illustrated in FIG. 1 and FIG. 2.

FIG. 7 shows a cross sectional view of a cylindrical atomiser of the kind shown in FIG. 4 as placed in the inlet duct of an internal combustion chamber, with alternative fluid flow control devices.

FIG. 8 show a part cross sectional view and a partial end view of an annular atomiser used in a gas turbine combustor in accordance with a fifth embodiment of the invention.

### DETAILED DESCRIPTION OF THE FIGURES

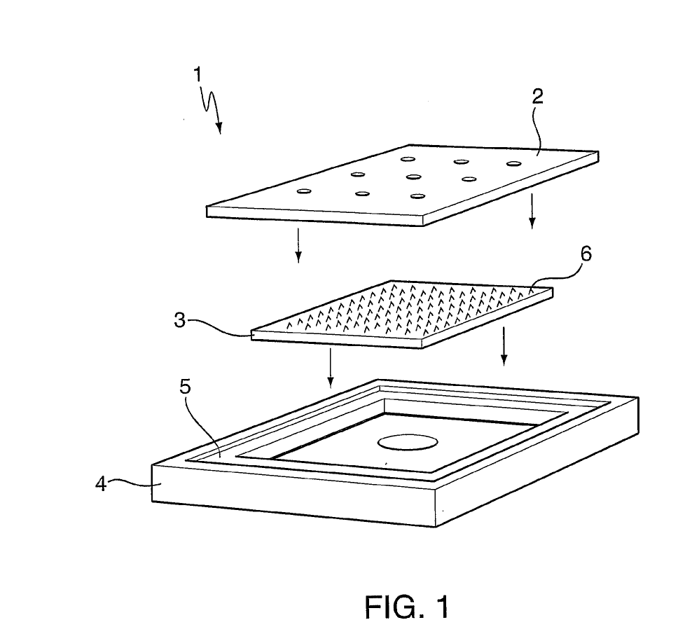

FIG. 1 shows an electrostatic atomiser generally referenced 1 having a nozzle plate 2, a high voltage electrode plate 3 and an atomiser body 4. Body 4 accommodates a fluid channel 5 around electrode plate 3. A high voltage connector may be provided between electrode plate 3 and a terminal (not illustrated in the drawing). The electrode plate incorporates a number of electrode points located in an array across the electrode top surface. One example of such electrode points is referenced 6 in the figure. These electrode points may be faceted elements as proposed in the applicant's own previous patent application PCT/GB2004/000458 whose teaching is enclosed by reference.

FIG. 2 shows the atomiser plate of FIG. 1 in assembled cross section. Identical features have retained identical numerical references for simplicity. In this configuration the nozzle or orifice plate 2 which incorporates a number of orifices 7 is earthed by electrode 8 extending through body 4. A high voltage electrode connector 9 is provided between a high voltage terminal and electrode plate 6. An electrostatic charging chamber 10 is formed between electrostatic plate 3 and nozzle plate 2. An inlet duct 111 is provided at a lateral location relative to the electrode plate.

Body 4 will be of a sufficiently insulating material to prevent a short circuit between high voltage electrode plate 3 and earthed nozzle plate 2.

Both electrode plate 3 and nozzle plate 2 are of substantially similar shape albeit in this configuration nozzle plate 2 is larger than electrode plate 3. Nevertheless all the orifices of the array such as orifice 7 are entirely covered by electrode plate 3 as the electrode plate 3 spans across the entire width of the array of nozzles. The body and nozzle plate are held together by an outer housing 12, which may be formed from an adhesive resin or other suitable material.

FIG. 3 shows a further electrostatic atomiser generally referenced 13 having two atomisers of the kind described with reference to FIGS. 1 and 2 but located back to back. In this configuration, there are two nozzle plates, an upper nozzle plate 14 and a lower nozzle plate 15 each incorporating an array of orifices. Orifice plate 14 corresponds to a substantially parallel electrostatic electrode plate 16 whilst nozzle plate 15 corresponds to electrode 17.

A single inlet duct (not illustrated in the figure) may be used to supply fluid to both nozzle plates simultaneously. High voltage connector 18 and an earthed electrode (not illustrated in the figure) may be provided to create the difference in potential between the high voltage electrodes and the nozzle plates. A resin 19 or other fixing means may be provided to join the plates together.

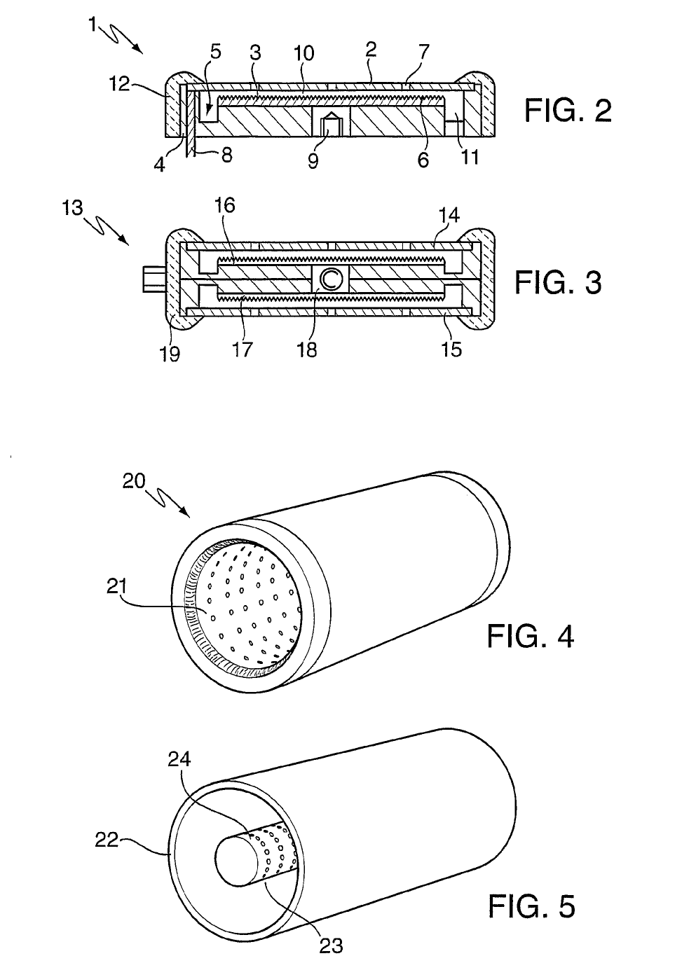

FIG. 4 shows an electrostatic atomiser generally referenced 20 of essentially cylindrical shape. The cylinder of FIG. 20 has an internal diameter at which a cylindrical nozzle plate 21 is provided with an array of orifices extending across the entire length of the cylinder.

Immediately behind the array of orifices an internal single cylindrical high voltage electrode plate may be provided in order to span essentially across the entire array of orifices. In a similar fashion as with the first and second embodiments of the invention the nozzle plate may be earthed whilst the high voltage electrode plate is connected to a high voltage source. The nozzle plate and the electrode plate are spaced one from another in order to form an electrostatic charging channel.

FIG. 5 shows a fluid conduit 22 in which a further electrostatic atomiser 23 is located. In this embodiment, the high voltage electrode will be located inside nozzle plate 24 and sufficiently spaced from nozzle plate 24 to form an electrostatic charging chamber. As the electrostatic atomiser 23 is supplied with fluid and an appropriate charge is supplied atomised fluid will flow out from the array of orifices which span the entire length of conduit 22. This configuration will cause particles to leave the atomiser in a radial direction throughout the entire length of the conduit thus achieving optimum mixing. Whilst the figure shows the atomiser placed in an essential central position in the conduit, the invention envisages particular advantages in placing the atomiser eccentrically within the conduit.

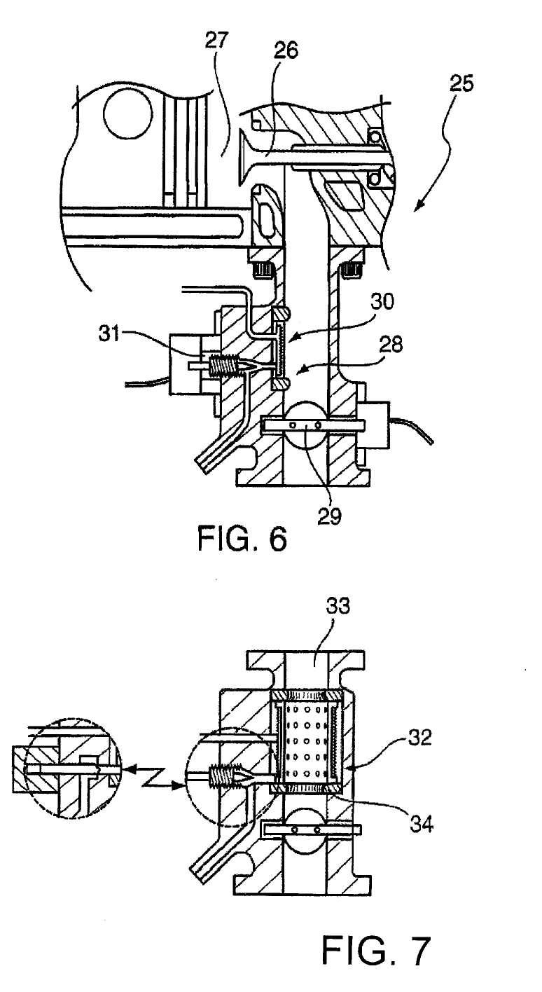

FIG. 6 shows an internal combustion engine mixing arrangement for air and fuel, the arrangement being referenced generally 25. The mixing arrangement is configured to supply a mixture of air and fuel via an inlet valve 26 into an internal combustion chamber 27. The mixing arrangement is placed within the air inlet duct 28 to which the supply of air is controlled by a valve 29 of known kind. As part of the wall of the inlet duct downstream from inlet valve 29 there is provided an electrostatic atomiser 30 of the kind illustrated in FIG. 2. In use the atomisers supply of fuel comes through variable control means 31 so as to exit the atomiser through an array of orifices located in line with the wall of the inlet duct but across a length of the inlet duct so that optimum mixing occurs.

FIG. 7 shows a further mixing arrangement generally referenced 32 also located in the air inlet duct of an internal combustion engine or other burner. Inside inlet duct 33 there is provided a cylindrical atomiser 34 of the kind illustrated and described with reference to FIG. 4. Alternative fuel flow control means are shown which may either control the flow in a series of cyclic pulses as with a pintle and solenoid or as a controlled variable continuous flow as with a needle valve and stepper motor.

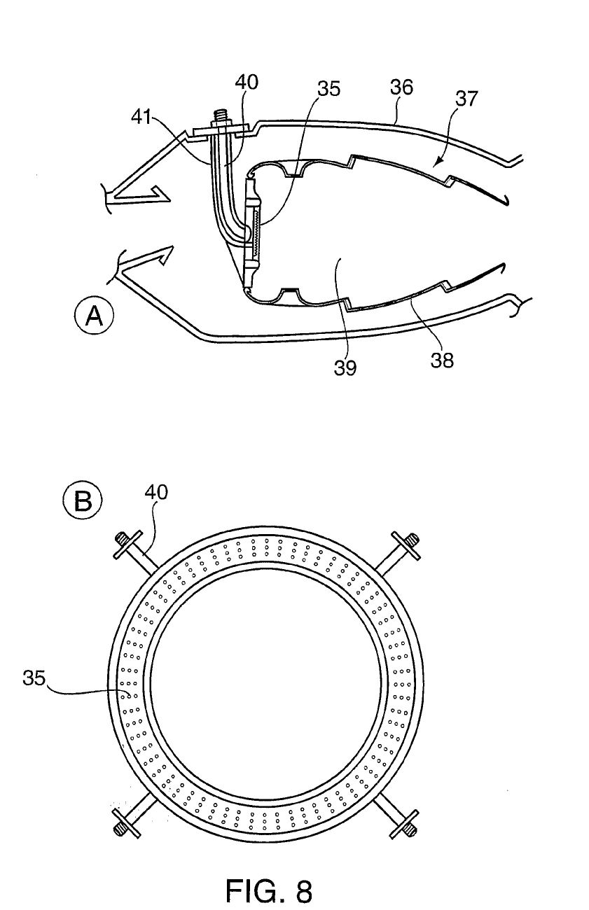

FIGS. 8a and 8b show an annular atomiser which in cross section is similar in structure to the atomiser of FIG. 2. Whilst the only modification to a conventional gas turbine fuel combustor is the insertion of the annular atomiser 35. The turbine incorporates an outer wall 36, a cooling duct 37, an inner combustor wall 38 and a combustor volume 39. The fuel input duct 40 stretches between outer wall 36 and fuel atomiser 35. Conjointly but externally from the fuel duct, there is provided the necessary high voltage connector 41. For clarity, FIG. 8b shows simply the fuel input duct referenced 40 and the electrostatic atomiser 35 of annular shape.

1. comprising an electrostatic atomiser which feeds a first fluid into a walled-channel where it mixes with a second fluid; the electrostatic atomiser incorporating a charging electrode and a nozzle with an array of orifices through which charged particles of the first fluid exit the atomiser; said charging electrode substantially spanning said array of orifices; and said charging electrode and said nozzle pointing neither into nor towards said channel but are shaped and sized to constitute a part of or the entire wall of said channel in which said first and second fluids are mixed; characterised in that all the orifices of the array are entirely covered by the charging electrode.

2. An electrostatic atomiser, comprising a fluid channel, a charging electrode located in said channel and a nozzle with an array of orifices through which charged particles of fluid exit the atomiser; said charging electrode substantially spanning said array of orifices; and said charging electrode and said nozzle have similar overall shapes; characterised in that all the orifices of the array are entirely covered by the charging electrode.

3. An atomiser according to claim 2, wherein the charging electrode and the nozzle are plates between which an electrostatic charging chamber is formed.

4. An atomiser according to claim 2, wherein the charging electrode and the nozzle form the side walls of a cylinder.

5. An electrostatic atomiser according to claim 2, wherein the charging electrode and the nozzle are substantially annular in shape.

6. An electrostatic atomiser according to claim 4, wherein the atomiser is located substantially longitudinally in a channel, the nozzle's orifices being arranged to cause the fluid to exit radially outwards.

7. A mixing arrangement according to claim 1, wherein the charging electrode and the nozzle are plates between which an electrostatic charging chamber is formed.

8. A mixing arrangement according to claim 1, wherein the charging electrode and the nozzle form the side walls of a cylinder.

9. A mixing arrangement according to claim 1, wherein the charging electrode and the nozzle are substantially annular in shape.

10. A medical drug delivery system incorporating a mixing arrangement according to claim 1.

11. (canceled)

12. An atomiser according to claim 3, wherein the charging electrode and the nozzle form the side walls of a cylinder.

13. A medical drug delivery system incorporating an electrostatic atomiser according to claim 2.
